(19) United States
(12) Patent Application Publication
(10) Pub. No.: US 2023/0245445 A1
(43) Pub. Date: Aug. 3, 2023

(54) AN OBJECT DETECTION METHOD

(71) Applicant: ESEN SISTEM ENTEGRASYON VE MUHENDISLIK HIZM. SAN VE TIC LTD. STI., Ankara (TR)

(72) Inventors: Poyraz Umut HATIPOGLU, Ankara (TR); Rafet Tufan ALBAYRAK, Ankara (TR); Abdullah Aydin ALATAN, Ankara (TR)

(73) Assignee: ESEN SISTEM ENTEGRASYON VE MUHENDISLIK HIZM. SAN VE TIC LTD. STI., Ankara (TR)

(21) Appl. No.: 18/010,485

(22) PCT Filed: Feb. 11, 2020
(86) PCT No.: PCT/TR2020/051025

§ 371 Date: Dec. 15, 2022

(30) Foreign Application Priority Data
Jul. 13, 2020 (TR) 2020/11054

(51) Int. Cl. G06V 20/17; G06T 7/215; G06T 7/507

(52) U.S. Cl. CPC G06V 20/17; G06T 7/215; G06T 7/507; G06T 2207/20224; G06T 2207/30232

(57) ABSTRACT

An object detection method for detecting objects under moving cloud shadow comprises two main sub-procedures linked to each other. The first main sub-procedure is for detecting the moving cloud region and its moving border regions. Once the moving border region is detected, a moving border mask is used to filter out the foreground objects located under the moving border regions. The filtered foreground objects include both real objects and the false alarms generated by abrupt intensity change caused by fast-moving cast cloud shadows. The decision for the elimination of possible false alarms is performed in the second main sub-procedure.

### CROSS REFERENCES OF THE RELATED APPLICATIONS

The application is a national stage entry of PCT/TR2020/051025 filed on Nov. 02, 2020, which claims priority to Turkish patent application No. TR 2020/11054 filed on Jul. 13, 2020, the entire contents of which are incorporated herein by reference.

### TECHNICAL FIELD

The present invention relates to an object detection method, and especially a method for detecting objects under moving cloud shadow.

### BACKGROUND

For a reliable and robust moving object detection, the subtraction of a precisely modeled background is crucial in wide-area motion imagery (WAMI). Even the most successful background subtraction algorithms that are designed to model highly-dynamic environments cannot cope with rapidly changing scenery, such as moving cloud shadows, which has different characteristics from dynamic textures.

Moving object detection and tracking are constantly developing active research areas in remote sensing and computer vision. WAMI is one of the most common wide-area surveillance data sources and has drawn attention in the last couple of decades. With the development in both imaging technology and unmanned aerial vehicle platforms, the attention to the fully automatic and real-time WAMI tracking systems have increased. WAMI solutions can be integrated into various platforms such as unmanned aerial vehicles (Lin, Medioni, 2007), aerostats (Nagendran et al., 2010), etc. and for numerous civil and military applications.

Targets whose resolution is considerably low are tried to be detected and be tracked in very large-scale WAMI videos. Even though there are a few multi-spectral solutions, most of the WAMI solutions use monochromatic (AFRL, 2009), (Force, n.d.), (Perera et al., 2006) imaging format depending on the application. Without the color information, there is a chance in that the intensity values of both target object and background can be quite similar or even the same. Hence detection and tracking of targets in a monochromatic solution can be challenging even if the data is captured in favorable weather and illumination conditions. Moreover, due to the negative effects of atmosphere related distortions, the object boundaries can be seen unclear or even completely blended to the background. Since a WAMI solution can monitor around tens of km2 region with hundreds of mega-pixel frame resolution, reducing the false alarm rate is quite critical. The reliability and usability of the product directly depend on both the detection ability of the targets and the accuracy of the detection. Hence any major false alarm sources are needed to be attacked to achieve a more robust and reliable solution.

Reliable background subtraction is the key operation to obtain moving foreground objects in the scene with high precision. To obtain an initial estimate and extract information of nonstationary objects numerous background subtraction methods with different working mechanisms have proposed (Piccardi, 2004), (Bouwmans et al., 2017), (Zivkovic, 2004). The precise modeling and constant updating of the model of background is the initial step of robust tracking performance (Sommer et al., 2016). Not only the discriminating power of moving objects from the background but also reducing the false alarm rate is the other requested ability of successful background subtraction technique. Since WAMI solutions try to monitor a largescale area persistently, the preferred background subtraction technique needs to work even for a highly dynamic environment. As waving tree branches (Elgammal et al., 2000), optical turbulence deformations (Oreifej et al., 2(012), stabilization related defects, and illumination changes (Pilet et al., 2008), fast-moving cast shadows is also one of the major challenges that background subtraction method needs to deal with by using its adaptivity property. At the same time, the preferred background detection algorithm needs to be computationally efficient to work operationally in real-time solutions.

Even spatially strengthened versions of the Gaussian mixture model (Sommer et al., 2016), (Reilly et al., 2010) cannot cope with fast-changing stationary signals, such as moving cloud shadows. To prevent the generation of false objects (false alarms) caused by the motion of cloud shadows, the moving section of cloud shadows needs to be identified. During the last decade, various cloud shadow detection methods (Li et al., 2017), (Zhu, Woodcock, 2012), (Simpson, Stilt, 1998) have been designed and implemented to improve the performance of the different applications, such as feature extraction, segmentation, classification (Li et al., 2017). However, nearly all the current cloud detection algorithms have used either multispectral information (Luo et al., 2008), (Simpson, Stilt, 1998) or the geometrical properties of the cloud and orientation of imaging system (Braaten et al., 2015), (Huang et al., 2010). When monochromatic cameras are used, the algorithms, which are designed for multispectral information, cannot be utilized.

The Chinese patent application numbered CN110555818 in the state of the art discloses a cloud area repairing method in satellite image sequences. The method identifies and expands a cloud area and an under-cloud shadow area from a plurality of multispectral images of a target area respectively to generate a plurality of single-wave-band images.

The Japanese patent application numbered JP2004208209 in the state of the art relates to a method for monitoring a moving body. Even though this method takes into account the cloud shadows, it assumes that the cloud shadows are stationary, and construct the solution based on the image differentiation approach, which has many problems and drawbacks.

### SUMMARY

The objective of the invention is to provide an object detection method, and especially a method for detecting objects under moving cloud shadow.

Another objective of the invention is to realize object detection using monochromatic images.

Another objective of the invention is to realize object detection eliminating the dependence on the position of the sun and the shape of the scenery.

### BRIEF DESCRIPTION OF THE DRAWINGS

The object detection method in order to fulfill the objects of the present invention is illustrated in the attached figures, where:

FIG. 1 is a flow-chart of the moving cloud shadow detector of the object detection method.

FIG. 2 is a flow-chart of the moving object filtering of the object detection method.

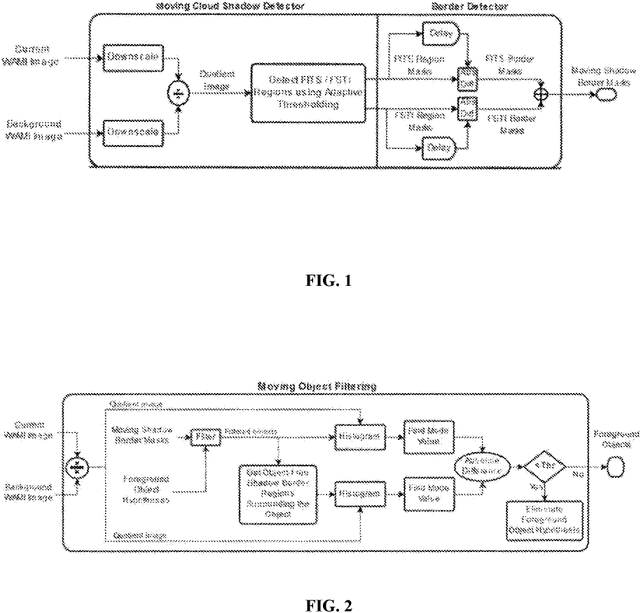

### DETAILED DESCRIPTION OF THE EMBODIMENTS

If the direct light is blocked by object completely, that section of the cast shadow is classified as umbra whilst if a light source is blocked partially, the darkening region of the shadow is called the penumbra.

The opacity of the occluding object and both the location and the geometry between the light source and occluding object determine the penumbra region of the cast shadow. The luminance transition in the penumbra region of the cast shadow canbe assumed as linear for an opaque and solid occluding object. (Stander et al., 1999). However, due to having non-uniform density and random 3D geometry, even if we can assume that the luminance of the cloud shadows rises from the inside to the outside, the structure of the penumbra regions of the cloud shadow cannot be represented mathematically.

The intensity (brightness) value of a point (x, y) which is the 2D projection of the object surface at point q and time instant t, can be expressed as

$${C}_{t} \left(x , y\right) = {k}_{c , t} \left(x , y\right) ⋅ {E}_{t} \left(x , y\right)$$

where;
Cₜ : intensity value of a pixel at time instant t,
x, y : image coordinate of the object surface point q,
k_{c,t} : camera gain at time instant t,
Eₜ : luminance at time instant t.

By using the reflection model, the luminance at time instant t can be modeled as

$${E}_{t} \left(x , y\right) = {ρ}_{t} \left(x , y\right) ⋅ {S}_{t} \left(x , y\right)$$

where;
pₜ : the reflectance of the object at point q and time t,
Sₜ : irradiance at time t.

Depending on the illumination conditions, in the (Stander et al., 1999) the reflectance St has been represented as

$$S \left(x , y\right) = \left\{\begin{matrix}{c}_{P} ⋅ cos \left(θ\right) + {c}_{A} , n o s h a d o w \\ {c}_{P} ⋅ cos \left(θ\right) ⋅ k \left(x , y\right) + {c}_{A} , p e n u m b r a \\ {c}_{A} , u m b r a\end{matrix}\right)$$

According to Lambert’s cosine law (Basri, Jacobs, 2003), the angle 0 between the direction of the incident light and the surface normal defines the contribution amount of the direct light source to the irradiance of the surface at point q. Depending on the light transition of the penumbra region of cast shadow, the k(x, y) value varies in the range of [0, 1].

According to a taxonomy (Al-Najdawi ct al., 2()12), the shadow detection algorithms can be clustered concerning their dependencies on objects and the environment. Moreover, the number of spectral bands used and the implementation domains have also used to categories the shadow detection algorithms.

The reflection model presented in (Stander et al., 1999) has formed the basis of many methods (Toth et al., 2004), (Lu et al., 2006), (Vargas et al., 2010). The idea is the usage of the ratio between the pixel intensity values in the current frame (collected u seconds later than the reference) and that in the reference frame as shown in Formula 4.

$${ξ}_{t + u , t} \left(x , y\right) = \frac{{c}_{t + u} \left(x , y\right)}{{c}_{t} \left(x , y\right)}$$

According to formulas 1 and 2, formula 4 can be expanded as

$${ξ}_{t + u , t} \left(x , y\right) = \frac{{k}_{c , t + u} \left(x , y\right) ⋅ {ρ}_{t + u} \left(x , y\right) ⋅ {S}_{t + u} \left(x , y\right)}{{k}_{c , t} \left(x , y\right) ⋅ {ρ}_{t} \left(x , y\right) ⋅ {S}_{t} \left(x , y\right)}$$

Since the reflectance value of the background region does not change in time ₗ₊ᵤ(x,y) = pt(x,y)) and one can control the gain value, kc, of the camera we can simplify Formula 5 as

$${ξ}_{t + u , t} \left(x , y\right) = \frac{{S}_{t + u} \left(x , y\right)}{{S}_{t} \left(x , y\right)}$$

Since the umbra and penumbra regions of the shadow have different illumination characteristics, when shadow-free background region in the background frame is covered by moving cloud regions in the current frame the ratio of irradiances (ξ′_{t+u,t}) should be calculated as follows (Al-Najdawi et al.,2012):

$${{ξ}^{′}}_{t + u , t} \left(x , y\right) = \left\{\begin{matrix}\frac{{c}_{A}}{{c}_{P} ⋅ cos \left(θ\right) + {c}_{A}} , n o s h a d o w t o u m b r a \\ \frac{{c}_{P} ⋅ cos \left(θ\right) ⋅ k \left(x , y\right) + {c}_{A}}{{c}_{P} ⋅ cos \left(θ\right) + {c}_{A}} , n o s h a d o w t o p e n u m b r a\end{matrix}\right)$$

In (Stander et al., 1999) the ratio (Formula 6) is used to detect the shadow regions. However, the study assumes that the intensity values of the background in a defined neighborhood remain constant. This assumption cannot hold for the very complex background environment visualized in wide area surveillance. In fact, even in indoor environments, it is quite hard to rely on this assumption. Furthermore, this study also assumes that the object occludes the direct light source is opaque and hence, the intensity change in the penumbra field of the object shadow is approximately linear. However, due to the unique random structural density of each cloud bank, the penumbra region of the shadows might show a unique transition property.

In one of the studies, the author (Toth et al., 2004) calculates the values for foreground objects by taking the average of the ratio (6) over sliding window pixels.

Then Gaussian white noise is added to the {t+u,t values to test the stability of the designed method. By using the shadow-free background and calculated value the foreground image is tried to be estimated. The major contribution of the study (Toth et al., 2004) is that a significance test is derived to extract the shadow regions. However, the algorithm ignores the penumbra region of the shadow by stating that the penumbra region is very small and sometimes not recognizable. According to (Stander et al., 1999), the statement cannot be valid unless the distance between the occluding object and background is negligible compared to the distance between the light source and occluding object. Moreover, the occluding object must be opaque to confirm the statement of (Toth et al., 2004). Since cloud regions do not comply with these two assumptions, the developed approach cannot be used as a moving cloud shadow detector.

In a different approach, the author (Jacques et al., 2005) uses the normalized crosscorrelation (NCC) statistic between the background pixels and the foreground pixels in a close neighborhood. The NCC metric can produce reliable scores for the umbra regions, since the NCC score is not affected by the multiplication of each pixel with a positive constant value. However, the intensity change ratio is not the same for every pixel in a neighborhood of a penumbra region due to the variable k(x,y) value as shown in (7). Hence, the performance of the shadow detection algorithm is quite poor for the penmbra regions as stated in (Al-Najdawi et al., 2012).

According to (Al-Najdawi etal., 2012), the algorithms developed by (Xu et al., 2004), and (Chien et al., 2002) are applicable for just specific indoor environments. The algorithm of (Jung, 2009) is too complicated to work in real-time applications and highly parameter-dependent.

As mentioned earlier, since it is not known whether the randomly selected reference frame has cloud shadow regions or not, the irradiance ratio calculation for newly illuminated areas should also be one of the main concerns of the proposed study. The irradiance ratio calculation for the first-shadowed-then-well-illuminated areas (FSTI) should be calculated as demonstrated in Formula 8:

$${{ξ}^{″}}_{t + u , t} \left(x , y\right) = \left\{\begin{matrix}\frac{{c}_{P} ⋅ cos \left(θ\right) + {c}_{A}}{{c}_{A}} , u m b r a t o n o \\ \frac{{c}_{P} ⋅ cos \left(θ\right) + {c}_{A}}{{c}_{P} ⋅ cos \left(θ\right) ⋅ k \left(x , y\right) + {c}_{A}} , p e n u m b r a t o n o s h a d o w\end{matrix}\right)$$

The object detection method comprises two main sub-procedures linked to each other. The first main sub-procedure is detecting the moving cloud region and its moving border regions.

Once the moving border region is detected, moving border mask is used to filter out the foreground objects located under the moving border regions.

The filtered foreground objects include both real objects and the false alarms generated by abrupt intensity change caused by fast-moving cast cloud shadows.

The decision for the elimination of possible false alarms is performed in the latter main block.

In the proposed method, two major assumptions are made to detect moving parts of the cloud shadows. As in (Sexton, Zhang, 1993) and most of the reflectance ratio related studies, the intensity of the direct light source, cp, is assumed to be high compared to the ambient light source, CA. If it is not the case, the shadow regions cannot be differentiated properly, but since the background subtraction algorithm can suppress the small intensity changes, the object detection, and tracking algorithm will not be affected. The second assumption is that the WAMI video frames can be registered to the reference (background) frame with negligible error. Without this latter assumption, pixel-wise or region-wise temporal information cannot be exploited.

In a video sequence, the changes due to a shadow can be analyzed by computing the ratio of intensity values in the current frame with the intensity values in the reference frame. If the reference frame could be selected among cloud shadow-free frames, the proposed algorithm would work as a cloud shadow detection algorithm instead of a detection algorithm for the moving part of the cloud shadow. Since the reference frame can have cloud shadows, one can analyze the first-wellilluminated-then-shadowed (FITS) and first-shadowed-then-well-illuminated (FSTI) regions only to find the moving parts of the cloud shadows. In other words, there is no chance to detect the stationary parts of the cloud shadows without having the prior information of the shadow map of the reference frame.

Since in addition to the stable background regions, moving objects also can be covered by the cloud shadows either on the reference or current image, the reflectance ratio calculated using Formulas (7) or (8) might yield discontinuities even for the umbra regions of cloud shadows. To get rid of the discontinuities, a smoothing operation should be performed. Since the WAMI solutions are designed to work as a real-time application, the complexity reduction is always one of the key criteria at each stage of the algorithm. Hence in the proposed method, a downscaling operation has been applied for both the reference and the current images to reduce computational complexity and to get rid of the discontinuities caused by moving objects under the shadow region. In this presented approach, preferably, 10 times downscaling operation was applied for each dimension of the video sequence, however other number of downscaling operations may be utilized.

In this proposed method, we have exploited a few general properties of the cloud shadows. One of the major advantages of dealing with the cloud shadows is that the cloud shadows usually cover reasonable large areas and cannot be vanished by downscaling operation. Experimentally it is observed that tiny cloud banks create a slight intensity change in their shadow regions, sometimes they cannot create even any change. Hence in the proposed algorithm after obtaining the quotient (reflectance ratio) image by dividing the current downscaled image to the reference downscaled image, large spatially connected regions are searched which satisfy the desired reflectance ratio. To form masks for FSTI and the FITS regions similar adaptive-thresholding operations are applied for both such regions independently as explained below.

Adaptive thresholding on quotient image: In this step, it is desired to build a time-efficient and generalized method for the detection of the moving cloud shadow. Although there are many different ideas to detect moving cloud shadow regions using the reflection ratios, either their complexities or their assumptions made them inapplicable to our problem. Hence a modified adaptive thresholding approach has been designed. The double-thresholding approach explained in (Lyons, 2004) and the region growing method introduced in (Matas et al., 2004) are linked to each other to form this approach.

As mentioned earlier, since large spatially connected moving shadow regions arc detected to be found, in the first stage of the proposed thresholding method it is focused to find out core regions within the large moving cloud shadow areas. To acquire those core areas, an initial thresholding operation with predefined values is applied for both of the FSTI and the FITS regions. Since it was assumed that the intensity of the direct light source, cp, is high to be compared to the ambient light source, CA, the pixel intensity ratios demonstrated in both formulas 7 and 8 give clue to determine the initial thresholds.

For the FITS regions, formula 7 can be arranged as

$$\frac{{c}_{A}}{{c}_{P} ⋅ cos \left(θ\right) + {c}_{A}} \leq \frac{{c}_{P} ⋅ cos \left(θ\right) ⋅ k \left(x , y\right) + {c}_{A}}{{c}_{P} ⋅ cos \left(θ\right) + {c}_{A}} \leq 1$$

For the FSTI regions, formula 8 can be arranged as

$$1 \leq \frac{{c}_{P} ⋅ cos \left(θ\right) + {c}_{A}}{{c}_{P} ⋅ cos \left(θ\right) ⋅ k \left(x , y\right) + {c}_{A}} \leq \frac{{c}_{P} ⋅ cos \left(θ\right) + {c}_{A}}{{c}_{A}}$$

In (Toth et al., 2004), it is stated that the intensity value ratio for the umbra part of FITS regions varies between 0.77 and 0.97. After extensive studies, empirically it is found that unless cos(θ) term of both formula 9 and formula 10 takes very small values (e.g in dusk), we can specify the predefined thresholds. Hence it is decided that 0.85 is a slack enough to be safe starting threshold to find core areas of the FITS regions. However, the said threshold value may be between 0.97 and 0.77. As formula 8 is the inverse of the formula 7, for the FSTI regions the initial threshold was preferably defined as 1/0.85 (1.176). However, the initial threshold may be selected between 1/0.77 (1.299) ad 1/0.97 (1.031).

The regions with a lower reflectance value than the initial threshold constitute the core areas of the FITS region. Small regions that were not spatially connected are discarded from the mask of the core regions using basic morphological operations.

Here, the core area as explained above has been used as core mask.

After obtaining the mask of the core regions, they are tried to be grown, after utilizing multiple thresholds, using the following steps:
Start with the predefined initial thresholds (201),
Measure the ratio of the number of connected component regions without cores to the number of connected component regions (I) (202),
Measure the ratio of newly added pixels to connected components with the already available pixels (Il) (203),
Determine If either (I) or (Il) exceed the predefined ratio levels (204),
If either (I) or (Il) exceed the predefined ratio levels then stop (205),
If none of (I) or (Il) exceed the predefined ratio levels, increase the threshold with a predefined step size (206) and repeat the procedure starting from step 202,
Get the enlarged regions including core regions as the moving section of the cloud shadow regions (207).

Each of the masks areas are defined as connected component regions. If a connected component region contains core masks, then this is defined as connected component regions with cores. If the connected component regions do not contain core masks, then this is defined as connected component regions without cores.

The same procedure explained in the above-mentioned steps is repeated for FSTI regions by decreasing the threshold value defined for the FSTI areas.

Moving shadow border detection: The absolute difference between the FITS masks of the current (t) and earlier (t - v) frame gives the moving border mask of FITS regions as presented below:

$$B M \left(x , y\right) = \left|S {M}_{t} \left(x , y\right) - S {M}_{t - v} \left(x , y\right)\right| , ∀ \left(x , y\right)$$

where;
x; y : image pixel coordinate,
BM : moving border mask,
SM : moving cloud shadow mask.

The moving border mask for the FSTI regions can also be detected with the same operation. In other words, the final changed parts of the cloud shadow regions are marked as the border regions.

The v value in (11) needs to be determined by concerning the behavior of the background subtraction algorithm used to get foreground object candidates. In the presented approach, a spatially strengthened version of (Zivkovic, 2004) is applied and especially the learning rate and sigma distance that are used in (Zivkovic, 2004) drastically affect the region of the border in order to filter out object candidates.

Based on the value of v, it is possible to obtain quite narrow or wide boundary regions.

Moving object filtering under cloud regions: To analyze the foreground object candidates under the border regions of the moving cloud shadows, the candidates were filtered using the sum of border masks. The real moving objects are tried to be selected among all candidates by analyzing the relation between the object candidate and cloud border regions (background) surrounding the candidate on the quotient image. It should be noted that in this part of the study, all the operations are preferably performed on the quotient image on the original scale.

The reflectance ratio distribution of the background border regions is highly consistent in a close neighborhood even for the penumbra region. If the candidate object is a false alarm belonging to the stable background the distribution of the candidate and the surrounding region shows very similar characteristics. The key idea behind this procedure is that one should exclude the other candidate objects in the background to get reliable statistics belonging to the surrounding region of the object candidates. Otherwise, the real moving objects located in the surrounding region of the candidate can misguide the object surround analysis. If the candidate object is a real moving object, it is assumed that the distributions of the candidate and surrounding region shows distinct characteristics on the quotient image.

For the sake of simplicity and computational efficiency, for discriminating the real objects from the false alarms, the mode values of the distributions are used. The key idea is that the distribution of the object does not resemble the FITS or FSTI version of the background. Hence the mode value of the object and its surrounding regions is expected to have a different mode intensity value on quotient image. However, if it is not the case, the object candidate cannot be differentiated from the background and it will be eliminated. In order to eliminate the non-real object candidates, the thresholding operation to the absolute difference of the mode values is shown as follows:

$$\left|{M}_{0} \left(c e n\right) - {M}_{0} \left(s u r\right)\right| {\geq }^{?} t h r \text{\_} m o d e$$

where;
cen : image patch showing the object,
sur : image patch showing surrounding of the object,
thr_mode : real moving object threshold value.

In order to evaluate the performance of the proposed method, three datasets have been obtained. All of the three datasets are captured by using an Aerostat WAMI solution with an 8-bit gray-level imaging format at different times and different locations. The video frames that the proposed algorithm has been tested with were selected from a time span between 5 minutes to 20 minutes later than the reference (background) frame was captured for each dataset. Each of the three datasets has a single reference image and three testing images taken from the video sequences.

To evaluate the performance of the moving cloud shadow detection stage of the proposed algorithm in a quantitative way the data is annotated by drawing ground truths for each image. The total detection performance of both regions defines our scene-based performance.

The recall, precision and Fl score (Goutte, Gaussier, 2005) are well-known and common evaluation metrics used to validate the pixel-wise performance of the application of detection, segmentation, and classification, etc. Therefore, these metrics were used to evaluate the performance of the first stage of the proposed method. We have repeated the same detection procedure for the 3 testing scenes of each dataset then the mean performance results of each dataset have reported in the first three rows of Table 1. In the last two rows of Table 1, the mean elapsed times during the detection procedure and resolutions of the video frames are shown respectively.

TABLE 1

Performance Results of Proposed Moving Cloud Detection Algorithm

| Datasets | Set 1 | Set 2 | Set 3 |
|---|---|---|---|
| Mean Recall | 0.8477 | 0.8082 | 0.8361 |
| Mean Precision | 0.8583 | 0.8449 | 0.8686 |
| Mean F1 score | 0.8524 | 0.8216 | 0.8517 |
| Detection Time (ms) | 22.5 | 24.45 | 5.48 |
| Resolution (megapixels) | 130.14 | 130.14 | 28.83 |

The proposed method is executed in an Intel Core i7-7700 3.60 GHz 16GB RAM, GeForce GTX 1050 Ti PC system. The total execution time for filtering out moving objects in the elimination operation of the false alarms generated by cloud shadows is varying depending on the number of objects subjecting to the mode value comparison operation, as well as the system on which the inventive method is implemented. The average time spent for the boundary identification stage is 15.8983 ms per video frame and mode value comparison stage for a candidate object lasts approximately 0.0613 ms. Although the test applied to eliminate false alarms takes 0.0613 ms the total time can rise to tens of milliseconds depending on the number of object candidates in borders of the shadow regions.

In the following, the WAMI images are obtained via an image source, and the other steps are executed by one or multiple processing means.

In the preferred mode of operation, the inventive method is carried out as follows:
Obtaining, via an image source, a current WAMI image,
Obtaining, via an image source, a background WAMI image,
Downscaling the said images via a processing means,
Dividing the said images to each other thereby obtaining a quotient (reflectance ratio),
Searching the downscaled current WAMI image for the regions which satisfy the predetermined reflectance ratio, using formula 9 for FITS regions and formula 10 for FSTI regions,
Determining core masks for FITS and FSTI regions,
Calculating the difference between FITS and FSTI regions according to formula 11, thereby determining border mask,
Hypothesizing an object candidate, and obtaining histogram thereof,
Obtaining object-free shadow border regions surrounding the hypothesized object, and obtaining histogram thereof,
Finding mode values of said histograms,
Calculating absolute differences of said mode values,
Deciding, by comparing the said absolute difference of the mode values to a predetermined threshold value, if the hypothesized object is really a foreground object or not.

The histograms of the object candidate and the object-free shadow border regions surrounding the hypothesized object are obtained preferably from the quotient image.

Since the calculations do not involve the position of the sun or the distance to the cloud, the proposed method is independent from both, and the sun and the clouds do not need to be observed.

Additionally, the proposed method works with monochromatic images and therefore, using multispectral images is not needed. This ensures an increase in processing speed, and reduces the bandwidth required for image processing.

1. A method for detecting objects under moving cloud shadows comprising the steps of:
obtaining, via an image source, a current WAMI image;
obtaining, via an image source, a background WAMI image;
dividing the images against each other to obtain a quotient indicating a predetermined reflectance ratio;
searching a downscaled current WAMI image for the regions which satisfy the predetermined reflectance ratio, according to formula:
$$\frac{{c}_{A}}{{c}_{P} ⋅ cos \left(θ\right) + {c}_{A}} \leq \frac{{c}_{P} ⋅ cos \left(θ\right) ⋅ k \left(x , y\right) + {c}_{A}}{{c}_{P} ⋅ cos \left(θ\right) + {c}_{A}} \leq 1$$
for FITS regions and formula:
$$1 \leq \frac{{c}_{P} ⋅ cos \left(θ\right) + {c}_{A}}{{c}_{P} ⋅ cos \left(θ\right) ⋅ k \left(x , y\right) + {c}_{A}} \leq \frac{{c}_{P} ⋅ cos \left(θ\right) + {c}_{A}}{{c}_{A}}$$
and for FSTI regions,
determining core masks for FITS and FSTI regions,
calculating the difference between FITS and FSTI regions according to formula
$$B M \left(x , y\right) = \left|S {M}_{t} \left(x , y\right) - S {M}_{t - v} \left(x , y\right)\right| , ∀ \left(x , y\right)$$
for determining a border mask,
hypothesizing an object candidate, and obtaining histogram thereof,
obtaining object-free shadow border regions surrounding a hypothesized object, and histogram thereof,
finding mode values of said histograms,
calculating absolute differences of said mode values,
deciding, by comparing the said absolute difference of the mode values to a predetermined threshold value, if the hypothesized object is really a foreground object or not;
wherein the steps are executable by one or multiple processing means.

2. The method according to claim 1, wherein after obtaining the mask of the core regions, the mask of the core regions is utilized with multiple thresholds via, the following steps:
starting with the predefined initial thresholds,
measuring the ratio of the number of connected component regions without cores to the number of connected component regions, denoted as I,
measuring the ratio of newly added pixels to connected components with the already available pixels, denoted as II,
determining if either I or II exceeds the predefined ratio levels,
if either I or II exceed the predefined ratio levels then stop,
if none of I or II exceeds the predefined ratio levels, increasing the threshold with a predefined step size and repeating the procedure starting from step “measuring the ratio of the number of connected component regions without cores to the number of connected component regions”,
getting the enlarged regions including core regions as the moving section of the cloud shadow regions.

3. The method according to claim 2, wherein the steps of claim 2 are repeated for FSTI regions by decreasing the initial threshold value determined for the FSTI regions.

4. A data processing device comprising a processor adapted to perform the steps of the method according to claim 1.

5. A computer program comprising instructions which, when the program is executed by a data processing device, cause the data processing device to carry out the steps according to the method of claim 1.

6. A computer-readable data carrier having stored thereon the computer program according to claim 5.

7. The data processing device according to claim 4, wherein after obtaining the mask of the core regions, the mask of the core regions is utilized with multiple thresholds via the following steps:
starting with the predefined initial thresholds,
measuring the ratio of the number of connected component regions without cores to the number of connected component regions, denoted as I,
measuring the ratio of newly added pixels to connected components with the already available pixels, denoted as II,
determining if either I or II exceeds the predefined ratio levels,
if either I or II exceed the predefined ratio levels then stop,
if none of I or II exceeds the predefined ratio levels, increasing the threshold with a predefined step size and repeating the procedure starting from step “measuring the ratio of the number of connected component regions without cores to the number of connected component regions”,
getting the enlarged regions including core regions as the moving section of the cloud shadow regions.

8. The data processing device according to claim 7, wherein the steps of claim 7 are repeated for FSTI regions by decreasing the initial threshold value determined for the FSTI regions.

9. The computer program according to claim 5, wherein after obtaining the mask of the core regions, the mask of the core regions is utilized with multiple thresholds via the following steps:
starting with the predefined initial thresholds,
measuring the ratio of the number of connected component regions without cores to the number of connected component regions, denoted as I,
measuring the ratio of newly added pixels to connected components with the already available pixels, denoted as II,
determining if either I or II exceeds the predefined ratio levels,
if either I or II exceed the predefined ratio levels then stop,
if none of I or II exceeds the predefined ratio levels, increasing the threshold with a predefined step size and repeating the procedure starting from step “measuring the ratio of the number of connected component regions without cores to the number of connected component regions”,
getting the enlarged regions including core regions as the moving section of the cloud shadow regions.

10. The computer program according to claim 9, wherein the steps of claim 9 are repeated for FSTI regions by decreasing the initial threshold value determined for the FSTI regions.
